(19) United States
(12) Patent Application Publication
(10) Pub. No.: US 2010/0212782 A1
(43) Pub. Date: Aug. 26, 2010

(54) FLAIL CHAIN FOR USE IN DEBARKING TREES

(75) Inventors: Jinhuan Huangfu, Rossmoyne (AU); Phillip Morris Dohnt, Penola (AU)

Correspondence Address: BROWN & MICHAELS, PC;400 M & T BANK BUILDING, 118 NORTH TIOGA ST, ITHACA, NY, 14850, US

(73) Assignee: FUNCTION CHAIN PTY, LTD, Parkside Adelaide (AU)

(21) Appl. No.: 12/692,927

(22) Filed: Jan. 25, 2010

(30) Foreign Application Priority Data
Feb. 25, 2009 (AU) 2009200745

(51) Int. Cl. B27L 1/12; B27L 1/10

(52) U.S. Cl. 144/208.7; 59/90; 144/208.9

(57) ABSTRACT

A linkage element for a flail chain comprising more than two shank portions and more than two angled portions connecting the shank portions. The shank portions and angled portions define an interior space of the linkage element. A flail chain comprising at least one such linkage element forms a part of a flailing apparatus used to debark trees.

### FIELD OF THE INVENTION

The present invention broadly relates to a flail chain for use in debarking trees.

### BACKGROUND OF THE INVENTION

Bark needs to be removed from felled trees prior to the process of wood chipping. An apparatus commonly used for debarking trees is a flailing apparatus comprising a rotatable drum with a plurality of flail chains, each having one end fixed to the rotatable drum. Generally the flail chain comprises a plurality of substantially oblong shaped linkage elements.

During the debarking process, minor wear is caused to external surfaces of the linkage elements of the flail chains as they strike the tree bark. Significant wear occurs on internal surfaces of the linkage elements, particularly in opposing end regions where adjacent chain linkage elements engage with one another.

As a result of the aforementioned wear, flail chains must be regularly replaced. Consequently, the replacement of flail chains results in high capital expenditure and, by necessity, lost productivity in down time.

The present invention seeks to overcome at least some of the aforementioned disadvantages.

### SUMMARY OF THE INVENTION

In accordance with a first aspect of the present invention there is provided a linkage element for a flail chain, the linkage element comprising more than two shank portions and more than two angled portions connecting said shank portions, wherein said shank portions and said angled portions define an interior space of the linkage element.

It will be understood that, in use, no more than two angled portions of the linkage element may be arranged to engage with corresponding angled portions of adjacent opposing linkage elements. Accordingly, at any one time, one or more of the remaining angled portions will be unengaged. As it is unlikely in the course of use that any one of the angled portions will always remain engaged or unengaged, the wear arising from friction between adjacent engaged angled portions is substantially distributed between the angled portions of the linkage element, thus prolonging the wear period in comparison with prior art linkage elements. For instance, a linkage element of the present invention having four engaging regions is likely to take substantially twice as long to wear to the same extent as a prior art linkage element having only two portions to engage adjacent opposing linkage elements.

In one embodiment of the invention, the interior space of the linkage element is regularly shaped. The term “regularly shaped” as used herein refers to a substantially symmetric polygon. For example, in one form of the invention four shank portions and four angled portions may define a substantially square shaped interior space. In an alternative form, six shank portions and six angled portions may define a substantially hexagonal shaped interior space. In a further alternative form five shank portions and five angled portions may define a substantially pentagonal shaped interior space.

A regularly shaped interior space advantageously promotes even distribution of wear amongst all of the angled portions in the linkage element as no single angled portion is shaped in a manner which would bias its engagement or otherwise with a corresponding angled portion of an adjacent linkage element in comparison to the other angled portions of the linkage element.

In one form of the invention an exterior surface of any one of said angled portions may be curved. In an alternative form an exterior surface of any one of said angled portions may define a substantially straight edge transversely extending across the exterior surface.

A further advantage of the present invention is that the exterior surface of the one or more unengaged angled portions protrude outwardly from the linkage element and contribute to the flailing efficiency of a flailing chain comprised of said linkage elements.

It will also be appreciated that wear on an exterior surface of the linkage element of the present invention will also be prolonged and evenly distributed in comparison with prior art linkage elements because of the foregoing reasons.

In one embodiment, a cross section of any one of said shank portions may be substantially circular.

In accordance with a second aspect of the present invention there is provided a flail chain for debarking trees, the flail chain comprising a plurality of sequentially linked linkage elements as defined in accordance with the first aspect of the invention.

In accordance with a third aspect of the present invention there is provided a flailing apparatus for debarking trees, the flailing apparatus comprising:
a rotatable drum having a plurality of apertures;
at least one rod extending longitudinally through the drum and being positioned radially inwardly of the apertures; and
a plurality of flail chains as defined in accordance with the second aspect of the invention, each flail chain having a first end fixed to the at least one rod and extending outwardly through a respective aperture.

### BRIEF DESCRIPTION OF THE DRAWINGS

FIG. 1a shows a front elevation of a linkage element for a flail chain in accordance with one embodiment of the present invention.

FIG. 1b shows a cross-sectional view A-A of the linkage element of Figure la.

FIG. 2a shows a front elevation of a linkage element in accordance with a further embodiment of the present invention.

FIG. 2b shows a cross-sectional view B-B of the linkage element of FIG. 2a.

FIG. 3 shows a front elevation of a flailing apparatus in accordance with an embodiment of the present invention.

FIG. 4 shows an isometric view of a flail chain device in accordance with an embodiment of the present invention.

### DETAILED DESCRIPTION OF SPECIFIC EMBODIMENTS

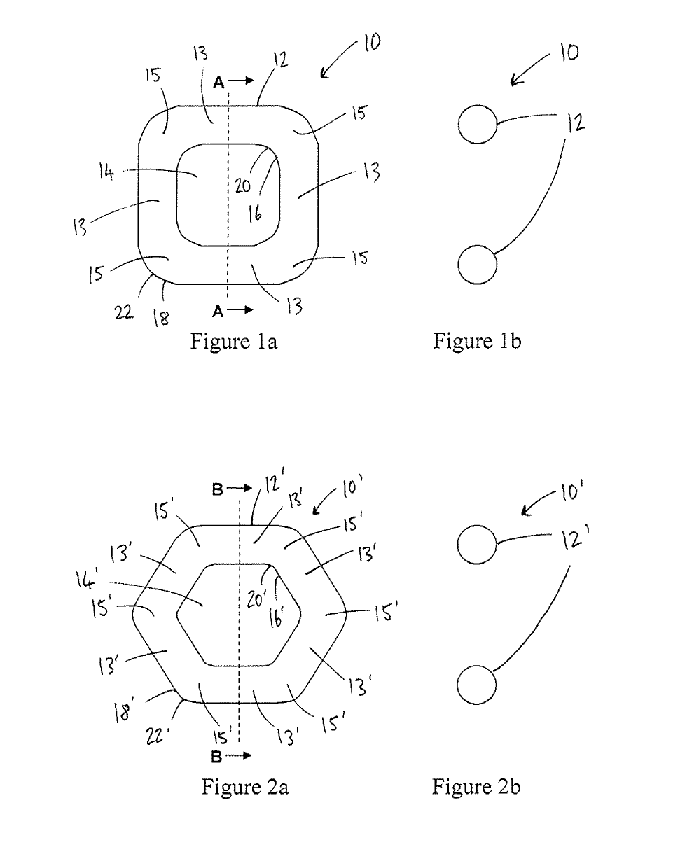

Referring to FIGS. 1 and 2 there are shown examples of linkage elements 10, 10′ in accordance with the present invention.

The linkage element 10 shown in FIG. 1a comprises a body 12 having four shank portions 13 and four angled portions 15 connecting said shank portions 13 so as to define a substantially square interior space 14.

The linkage element 10′ shown in FIG. 2a comprises a body 12′ having six shank portions 13′ and six angled portions 15′ connecting said shank portions 13′ so as to define a substantially hexagonal interior space 14′.

In other embodiments the linkage element 10 may be provided with an even number of shank portions 13 and angled portions 13 connecting said shank portions. Alternatively, the linkage element 10 may be provided with an odd number of shank portions 13 and angled portions 15 connecting said shank portions 13.

Regardless of the number of shank and angled portions 13, 15 in the linkage element 10 it is preferable that the body 12 of the linkage element 10 defines a regularly shaped interior space 14. In other words, it is preferable that the shank portions 13 of the linkage element 10 are substantially the same length as one another and the angled portions 15 of the linkage element 10 are disposed at substantially the same angle as one another.

A cross-section of the body 12 may be circular as shown in FIGS. 1b and 2b, although it will be understood that in alternative embodiments the body 12 may have a different shaped cross-section, such as for instance a square or a ribbed cross-section.

In the embodiments shown in FIGS. 1 and 2, an interior surface 16, 16′ of the angled portion 15, 15′ defines an inner corner 20, 20′ of the interior space 14, 14′. Similarly, the exterior surface 18, 18′ of the angled portions 15, 15′ defines an outer corner 22, 22′ of the body 12.

It will be understood by a skilled person in the art that by virtue of a typical mode of manufacture of the linkage element 10 of the present invention, the inner and outer corners, 20, 20′, 22, 22′ of the body 12, 12′ of the linkage element 10, 10′ are curved. Additionally, over time the inner and outer corners 20, 20′, 22, 22′ are likely to become further curved by virtue of frictional wear.

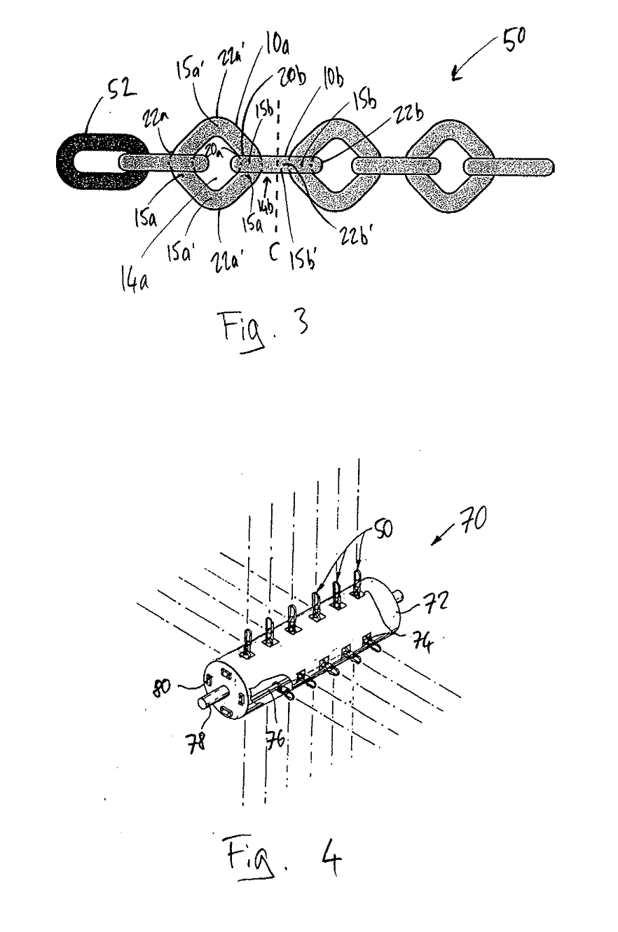

In use, a plurality of linkage elements 10 are arranged to be sequentially linked with one another, thereby forming a flail chain 50 as shown in FIG. 3. Each linkage element 10 is arranged to be linked to two opposing adjacent linkage elements 10. It will be appreciated that terminal linkage elements 10 may be linked to a single adjacent linkage element 10 or a prior art oblong linkage element 52.

It can be seen that adjacent linkage elements 10a, 10b are linked together by engaging respective angled portions 15a, 15b. The arrangement is such that outer corner 22a is disposed in interior space 14b of linkage element 10b, outer corner 22b is disposed in interior space 14a of linkage element 10a, and inner corners 20a, 20b bear against one another when the linkage elements 10a, 10b are placed under opposing tension. However, in contrast to prior art flail chains, in the embodiment shown in Figure 3, two opposing angled portions 15a′, 15b′ for each linkage element 10a, 10b remain unengaged. Furthermore, the two opposing outer corners 22a′, 22b′ for each linkage element 10a, 10b protrude outwardly from the flail chain 50. In use, the outwardly protruding outer corners 22a′, 22b′ strike the tree and therefore assist in flailing and removing bark from the tree. The outwardly protruding outer corners 22a′, 22b′ thus contribute to the flailing efficiency of both the flail chains 50 and a flailing apparatus 70, such as shown in FIG. 4, that employs a plurality of flail chains 50 of the present invention.

When linked together as described above, the interior space 14 of the linkage element 10 facilitates rotation of the linkage element 10 about a respective central longitudinal axis C such that there may be a period in which the unengaged angled portions 15a′, 15b′are engaged with adjacent angled portions 15, and the engaged angled portions 15a, 15b become disengaged from one another and protrude outwardly from the flail chain 50.

Over time, the ability of the linkage element 10 to rotate about its central longitudinal axis C ensures that any one of the angled portions 15 is likely to be disposed for a similar period of time in an engaged location as in an unengaged location in the flail chain 50. It follows that frictional wear on the external surface of the linkage element 10 caused by the flail chain 50 striking trees, although minor, is likely to be evenly distributed. The more frictional wear on the internal surface of the linkage element 10, particularly in the internal corners which bear against one another when adjacent angled portions are mutually engaged is likely to be evenly distributed because each angled portion spends a similar period in the engaged and unengaged locations in the flail chain 50.

As the frictional wear is distributed over more than two angled portions, the period of wear is effectively lengthened in comparison with prior art linkage elements where only two engaging portions of the linkage element are available for mutual engagement with adjacent linkage elements at any one time.

Flail chain 50 may comprise any combination of linkage elements 10 and prior art oblong linkage elements 52. Although FIG. 3 shows linkage elements 10 being substantially square in shape, it will be appreciated that the linkage elements 10 may be in the shape of any substantially symmetric polygon.

Referring now to FIG. 4 there is shown a flailing apparatus 70. Flailing apparatus 70 comprises a rotatable drum 72 having a plurality of apertures of 74. A rod 76 extends longitudinally through the drum 72 and is positioned radially inwardly of the plurality of apertures 74. A plurality of flail chains 50, each having a first end fixed to a rod 76, extend outwardly through respective apertures 74. In this example an oblong linkage element 52 is at the fixed end of each flail chain 50 and forms the connection to the rod 76. It will be appreciated however that a linkage element 10 may be arranged at the fixed end and may be used to form the connection between the fixed end of the flail chain 50 and the rod 76.

The drum 72 further comprises a shaft 78 for engaging with a drive so as to rotate the drum. The rotatable drum further comprises access holes 80 for accessing the rod 76 for maintenance purposes and the like.

It is to be understood that, although prior art use and publications may be referred to herein, such reference does not constitute an admission that any of these form a part of the common general knowledge in the art, in Australia or any other country.

For the purposes of this specification it will be clearly understood that the word “comprising” means “including but not limited to”, and that the word “comprises” has a corresponding meaning.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

1. A linkage element for a flail chain, the linkage element comprising more than two shank portions and more than two angled portions connecting said shank portions, wherein said shank portions and said angled portions define an interior space of the linkage element.

2. The linkage element of claim 1, wherein, in use, no more than two angled portions of the linkage element are arranged to engage with corresponding angled portions of adjacent opposing linkage elements.

3. The linkage element of claim 1,
wherein the interior space of the linkage element is regularly shaped.

4. The linkage element of claim 1, further comprising four shank portions and four angled portions that define a substantially square shaped interior space.

5. The linkage element of claims 1, further comprising five shank portions and five angled portions that define a substantially pentagonal shaped interior space.

6. The linkage element of claims 1, further comprising six shank portions and six angled portions that define a substantially hexagonal shaped interior space.

7. The linkage element of claim 1,
wherein an exterior surface of any one of the angled portions is curved.

8. The linkage element of claim 1, wherein an exterior surface of any one of the angled portions defines a substantially straight edge transversely extending across the exterior surface.

9. The linkage element of claim 1,
wherein an exterior surface of one or more unengaged angled portions protrude outwardly from the linkage element.

10. The linkage element of claim 1,
wherein a cross section of any one of the shank portions is substantially circular.

11. A flail chain for debarking trees, the flail chain comprising a plurality of sequentially linked linkage elements including more than two shank portions and more than two angled portions connecting said shank portions, wherein said shank portions and said angled portions define an interior space of the linkage element.

12. A flailing apparatus for debarking trees, the flailing apparatus comprising:
a rotatable drum having a plurality of apertures;
at least one rod extending longitudinally through the drum and being positioned radially inwardly of the apertures; and
a plurality of flail chains, each flail chain having a first end fixed to the at least one rod and extending outwardly through a respective aperture.

13. (canceled)

14. (canceled)

15. The flail chain of claim 11, wherein, in use, no more than two angled portions of the linkage element are arranged to engage with corresponding angled portions of adjacent opposing linkage elements.

16. The flail chain of claim 11, wherein the interior space of the linkage element is regularly shaped.

17. The flail chain of claim 11, further-comprising four shank portions and four angled portions that define a substantially square shaped interior space.

18. The flail chain of claim 11, further comprising five shank portions and five angled portions that define a substantially hexagonal shaped interior space.

19. The flail chain of claim 11, further comprising six shank portions and six angled portions that define a substantially hexagonal shaped interior space.

20. The flail chain of claim 11, wherein an exterior surface of any one of the angled portions is curved.

21. The flail chain of claim 11, wherein an exterior surface of any one of the angled portions defines a substantially straight edge transversely extending across the exterior surface.

22. The flail chain of claim 11, wherein an exterior surface of one or more unengaged angled portions protrude outwardly from the linkage element.

23. The flail chain of claim 11, wherein a cross section of any one of the shank portions is substantially circular.
